(19) United States
(12) Patent Application Publication
(10) Pub. No.: US 2021/0365969 A1
(43) Pub. Date: Nov. 25, 2021

(54) OFFER SELECTION OPTIMIZATION FOR PERSONA SEGMENTS

(71) Applicant: Punchh Inc., San Mateo, CA (US)

(72) Inventors: Darren Lieu, San Mateo, CA (US); Nancy Yu, Palo Alto, CA (US); Tian Lan, Foster City, CA (US)

(21) Appl. No.: 17/324,366

(22) Filed: May 19, 2021

Related U.S. Application Data
(60) Provisional application No. 63/027,251, filed on May 19, 2020.

(51) Int. Cl. G06Q 30/02; G06N 20/00

(52) U.S. Cl. CPC G06Q 30/0204; G06Q 30/0224; G06N 20/00; G06Q 30/0201; G06Q 30/0211

(57) ABSTRACT

Systems and methods are disclosed for selecting offers based on segmentation of users targeted for the offers. To personalize the offer selection for a user while avoiding the processing burden of selecting offers tailored at an individual user level, an offer selection optimizer system divides targeted users into persona segments based on the behavior of the targeted users with enterprises or offers. The system selects an offer based on initial weights applied to respective parameters of candidate offers, where the candidate offers may be scored using a weighting function. The weights may vary depending on the persona segment for which the offer is scored. The system may modify the initial weights to generate exploration weights, which are used to select exploration offers. Users' activities with the generated offers are tracked to update the initial weights. The system can generate subsequent offers using the updated weights.

### CROSS REFERENCE TO RELATED APPLICATIONS

This application claims the benefit of U.S. Provisional Application No. 63/027,251, filed May 19, 2020, which is incorporated by reference in its entirety.

### TECHNICAL FIELD

The present disclosure relates to personalized selection based on user behavior and more particularly, to reducing computer resources in performing personalized selection by segmenting users based on their behavior to optimize the personalized selection.

### BACKGROUND

Enterprises such as retail businesses often personalize offers to their customers. Enterprises target their customers with personalized offers to decrease the likelihood of a customer churning, reduce customer fatigue per promotional message, and increase brand awareness. Further, targeting customers also allows loyal customers to explore the catalogue of items and increase variety of items that a customer may purchase (e.g., purchases away from their “go-to” choice). However, targeting each individual customer with personalized offers is complex and time-consuming, requiring intensive computing resources including processing, power, and memory resources. Further, enterprises may target experimental offers to evaluate against the performance of offers previously selected for users. Determining experimental offers at an individual customer scale requires additional computing resources on top of resources needed for selecting one personalized offer for each customer.

### SUMMARY

Described herein are embodiments of systems and methods for selecting offers based on segmentation of users targeted for the offers. To personalize the offer selection for a user while avoiding the processing burden of selecting offers tailored at an individual user level, an offer selection optimizer system divides targeted users into segments, referred to herein as “persona segments,” based on the behavior of the targeted users with enterprises or offers. For example, users who share a behavior of visiting an enterprise infrequently may be grouped into a low frequency persona segment. Each persona segment may be characterized by a primary behavior that an offer is selected to influence. For example, while users in the low frequency persona segment may share similar behaviors in spending, their infrequent visits is the behavior that the offer selection optimizer system's or the enterprise's centers an offer selection strategy to influence (e.g., increase the frequency that the users visit the enterprise). The system can further divide users in a persona segment into sub-segments based on each users' item preferences.

By segmenting users and selecting an offer accounting for the behavior and/or preferences of a given persona segment, the system may use less computing resources (e.g., processing and memory) in selecting offers, as compared to selecting offers for each individual user, while maintaining a level of personalization for the offers to produce an intended behavior from the targeted users. The system may monitor the effect of offers selected using segmentation on subsequent activities of users (e.g., an increase or decrease in frequency in visiting an enterprise). This feedback may be used to optimize the segmentation or offer selection, decreasing the number of optimal offers the system may need to determine and transmit before the user-targeting achieves a desired objective (e.g., increasing a frequency at which users visit an enterprise). By reducing the number of future offer selection iterations needed, optimizing the segmentation or selection through feedback further reduces the computing resources needed to select targeted offers.

An offer selection optimizer system may identify a pool of targeted users for a given offer. The given offer may be characterized by offer parameters (e.g., discount amount, spending amount, affinity towards a user, etc.). The pool of targeted users are segmented into persona segments, where each persona segment may be characterized by activity parameters (e.g., frequency of visits to an enterprise, spending at the enterprise, etc.). The system determines, based on a given persona segment of the persona segments, initial weights to apply to the respective offer parameters. Exploration weights may be generated based on the initial weights. The system may use the exploration weights to generate exploration offers. The exploration offers may be transmitted to a first subset of the users segmented into the given persona segment and the given offer may be transmitted to a second subset of users within the given persona segment. The system may track activities of the first subset of users associated with the exploration offers and activities of the second subset of users associated with the given offer (e.g., a number of visits to an enterprise before and after the offer is transmitted). The initial weights may be updated based on the tracked activities. The system may generate a subsequent offer for the given persona segment based on the updated weights.

The persona segments may be further segmented into persona-item sub-segments. The system may identify a pool of content items, where the given offer is applicable for a subset of the pool of content items. The pool of content items may be segmented into content item segments. Targeted users of the given persona segment are segmented into sub-segments of targeted users based on the content item segments (e.g., users within the given persona segment are further segmented based on shared item preference). The subsequent offer may be provided for a sub-segment of the sub-segments of targeted users. The first and second subsets of targeted users within the given persona segment may be segmented into the same content item segment or into different content item segments. The system can generate the given offer using the content item segments. For example, for each targeted user of the first subset and for each candidate offer of a set of candidate offers, the system can determine a preferred content item of the candidate offer, where the preferred content item is associated with a qualification affinity score and a discounting affinity score. The system may calculate respective offer scores for each candidate offer based on a linear combination of the respective qualification affinity scores, discounting affinity scores, and initial weights.

Depending on whether the users are segmented into persona segments or persona-item sub-segments, the system may calculate offer scores differently. In some embodiments, the system bases the scores on persona segments. The system accesses candidate offers, each offer applicable for a set of content items having respective qualification affinity and discounting affinity scores. The system may determine, for each candidate offer, an offer score by determining a representative qualification affinity score and a representative discounting affinity score. The representative qualification affinity score may be determined based on the qualification affinity scores of the individual items of the offer, or “item qualification affinity scores,” that are greater than or equal to a threshold qualification affinity score. The representative discounting affinity score may be determined based on the discounting affinity scores of the individual items of the offer, or “item discounting affinity scores,” that are less than a threshold discounting affinity score. In some embodiments, the system bases the scores on item-persona sub-segments. For each user, the system may select the user's preferred item's item qualification affinity score as the offer's qualification affinity score and the user's preferred item's item discounting affinity score as the offer's discounting affinity score when calculating the offer score for that user.

The system may generate the first and second subsets of targeted users of the given persona segment by comparing the size of the given persona segment against a threshold size. If the size of the given persona segment is greater than or equal to the threshold size, the system may split the given persona segment into the first and second subsets using simple random sampling. If the size of the given persona segment is less than the threshold size, the system may split the given persona segment into the first and second subsets using stratified random sampling based on an activity parameter characterizing the given persona segment. In some embodiments, offer parameters may include one or more of a qualification affinity, discounting affinity, average realized discount rate, or an average gross spending. The system may generate exploration offers by determining a rank of candidate offers associated with the given persona segment and modify the rank. The system then selects exploration offers from a subset of the offers above a predetermined ranking in the modified rank. In some embodiments, the initial weights may be predetermined for the given persona segment. The activities performed by targeted users may be characterized by one or more of a frequency of visits to a location where the given offer may be redeemed, an amount spent at the location, a number of times the given offer is redeemed, or a visit to the location after the given offer has expired.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a network diagram illustrating a communication environment in which an offer selection optimizer system operates, in accordance with at least one embodiment.

FIG. 2 is a diagrammatic representation of persona segmentation determined by an offer selection optimizer system, in accordance with at least one embodiment.

FIG. 3 depicts a block diagram of offer selection processes using an offer selection optimizer system, in accordance with at least one embodiment.

FIG. 4 illustrates a block diagram of an offer weighting function used to select an offer for a persona segment, in accordance with at least one embodiment.

FIG. 5 depicts a block diagram of performance data generation through groupings of a persona segment, in accordance with at least one embodiment.

FIG. 6 depicts a block diagram of an optimization process for an offer weighting function used to select an offer, in accordance with at least one embodiment.

FIG. 7 shows a diagrammatic representation of an example computer system for implementing an offer selection optimizer system, in accordance with at least one embodiment.

FIG. 8 is a flowchart illustrating a process for selecting an offer, in accordance with at least one embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Architecture

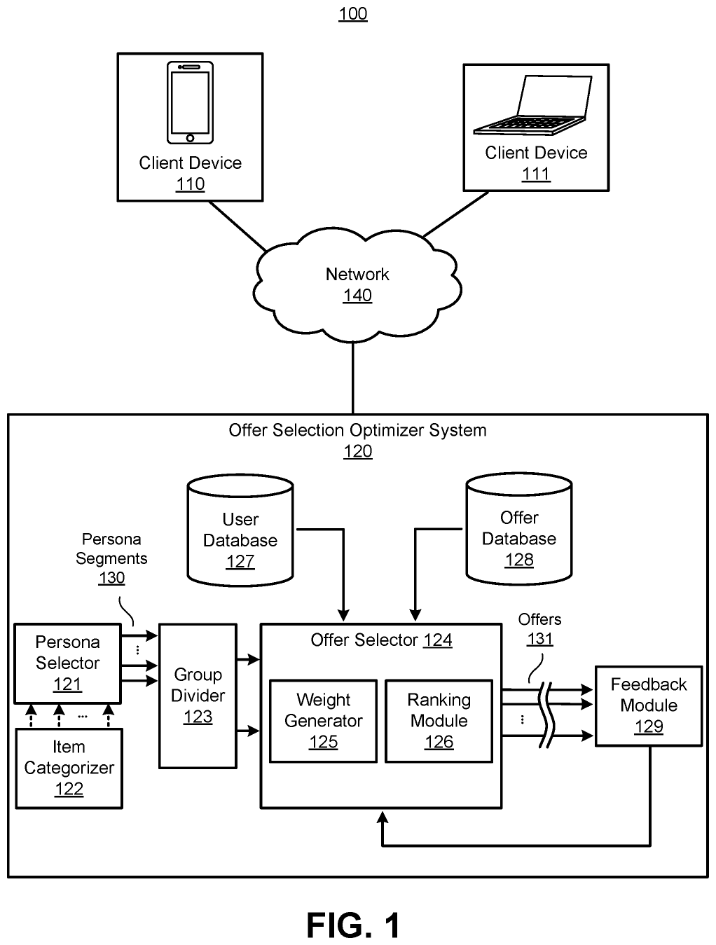

FIG. 1 is a network diagram illustrating communication environment 100 in which offer selection optimizer system 120 operates, in accordance with at least one embodiment. Communication environment 100 includes client devices 110 and 111, network 140, and offer selection optimizer system 120. In alternative configurations, different and/or additional components may be included in communication environment 100. For example, enterprises (e.g., retail businesses) on behalf of which offer selection optimizer system 120 selects offers may be included within communication environment 100. Offer information and/or selected offers may be communicated between the enterprises and system 120 (e.g., via network 140).

Systems and methods are described herein for selecting optimal offers in relation to persona segments or a combination of persona and item segments. In particular, the offer selection optimization system described herein determines segments of users from a pool of targeted users, where each segment is characterized by activity parameters describing activities of the targeted users with an enterprise. These segments of users based on activity parameters may be referred to herein as a “persona segment.” Activity parameters may include recency, frequency, spending, a number of day-part transactions, or any suitable metric for characterizing the activity of a targeted user with an enterprise. An enterprise may be a retail business, department store, super market, Internet retailer, small business, restaurant, or any suitable enterprise associated with (e.g., selling, aggregating, monitoring, etc.) an inventory of items and/or services.

One of the activity parameters characterizing a persona segment may be an actionable parameter whose value may be improved (e.g., the performance of the parameter is below a target performance goal). This parameter may be referred to herein as a “key parameter” and may be the primary activity parameter used by offer selection optimization system 120 to select an offer for the corresponding persona segment. The pool of targeted users may be segmented into groups such that each segment has an emphasis on a respective key parameter. That is, the groups may be segmented such that the system may emphasize a common goal for modifying the performance of the same key parameter among each targeted user in the segment. In one example, a persona segment may be a “low recency persona segment” that is characterized by a key parameter indicating that the recency of targeted users within the segment is performing below a target recency. In some embodiments, system 120 is not necessarily limited to using a single, key parameter for segmenting targeted users into persona segments. That is, multiple activity parameters characterizing a persona segment may be used to drive the offer selected for the persona segment.

Optionally, the system may further segment a persona segment based on one or more items or item categories the targeted users within the persona segment have the highest affinity towards. This reduces the dimensionality burden by allowing only a few high-level offers needing to be created at the persona segment level. Then, when targeting at the item-level, the persona segmented-based offer template is used and filled in with item-specific offers catered towards each sub-segment's highest affinity item(s). In some embodiments, the system may receive a user input specifying a type of segmentation (e.g., segmentation by persona or by both persona and items). The system may then perform persona segmentation according to the user input. For example, a user at an enterprise may provide user input specifying segmentation by both persona and item, where the system may optionally enable the user to specify a specific item for segmentation (e.g., a frequency purchased item).

While the system may be configured to generate new offers to present to targeted users, the system is primarily described herein as optimizing the selection an offer from existing offers. The term “existing offers” may also be referred to herein as “historical offers” or “available offers.” As referred to herein, “generating an offer” and “selecting an offer” may be used interchangeably and refer to the selection of an offer from historical offers unless specified otherwise by context (e.g., indicating a new offer is generated rather than selected from available offers). The system, in particular, accesses information about the historical offer. The offer's information may include items within the offer, the date at which the offer was first offered, targeted users to which the offer was provided, the discount offered, the frequency at which the offer was redeemed, the amount spent when redeeming the offer, etc.

The system is configured to select an offer that improves a key parameter's performance. Offers may be characterized by parameters such as the qualification affinity and/or discounting affinity of items within the offer, discount rate, gross spending, any suitable metric for characterizing an offer or a targeted user's affinity for an offer, or a combination thereof. These parameters may be referred to herein as “offer parameters.” The system determines offer parameters that can influence the performance of a persona segment's key parameters. Thus, offer parameters may be associated with a key parameter of a persona segment. The system compares candidate offers using the offer parameters associated with a key parameter. In one example of comparing offers, the system may use a weighting function to output scores for each offer. The system uses the scores to select an offer. Items in candidate offers may be organized into qualification and discounting portions of an offer. The system may determine an affinity score of the offer's qualification item set (“qualification affinity score”) and an affinity score of the offer's discounting item set (“discounting affinity score”), where the affinity scores may vary depending on a persona segment for which it is calculated.

Although not depicted in FIG. 1 as being a component of offer selection optimizer system 120, a recommendation module used to calculate affinity scores for items may be included. The recommendation module may use a statistical model correlating a targeted user with a particular item or a machine learning model trained on historical user activity indicating a likelihood that a targeted user has an affinity for a particular item. For example, a targeted user may have previously purchased items of a specific brand regardless of discount, and a recommendation algorithm may determine a qualification affinity score for an item of that brand that is relatively higher than scores determined for items of other brands. The system may also rank the affinity scores to compare a user's affinity for one item against affinity of another item. In another example, a targeted user may frequently purchase discounted items and rarely purchase other, non-discounted items. A recommendation algorithm may determine a high discounting affinity score for a discounted item for this targeted user and a low discounting affinity score for the same discounted item for a different, targeted user that rarely purchases discounted items. The affinity scores for items or item categories may be used to select offers for segments by persona or further sub-segmentation by item.

This offer optimizes processing resources needed to determine a personalized offer for a targeted user using segmentation while maintaining personalization based on characterizations of the targeted user (e.g., via activity parameters characterizing a segment). This offer may be referred to herein as an “optimal offer” or “optimized offer.” After selecting an offer, the system may monitor for the effects of the offer on the key parameter for a targeted user (e.g., monitoring for improved performance, or lift, of the key parameter) through a test (e.g., an A/B test) against a different type of offer (e.g., an offer that has not been personalized for the targeted user). The lift may impact metrics such as visit count, check size, total spending, or redemption rate.

The system may also update weights of a weighting function used to score candidate offers. The system may use A/B testing based on exploration and exploitation. During exploration, the system determines if a new offer (i.e., an offer that a targeted user has not yet received) performs better than a previously presented offer. For example, the system may determine if the new offer causes a decrease in the time between visits by a targeted user to an enterprise than the previously presented offer. If the system determines that the new offer performs better, the system may adjust the weights used in the weighting function to increase the likelihood that the new offer is selected for the targeted user.

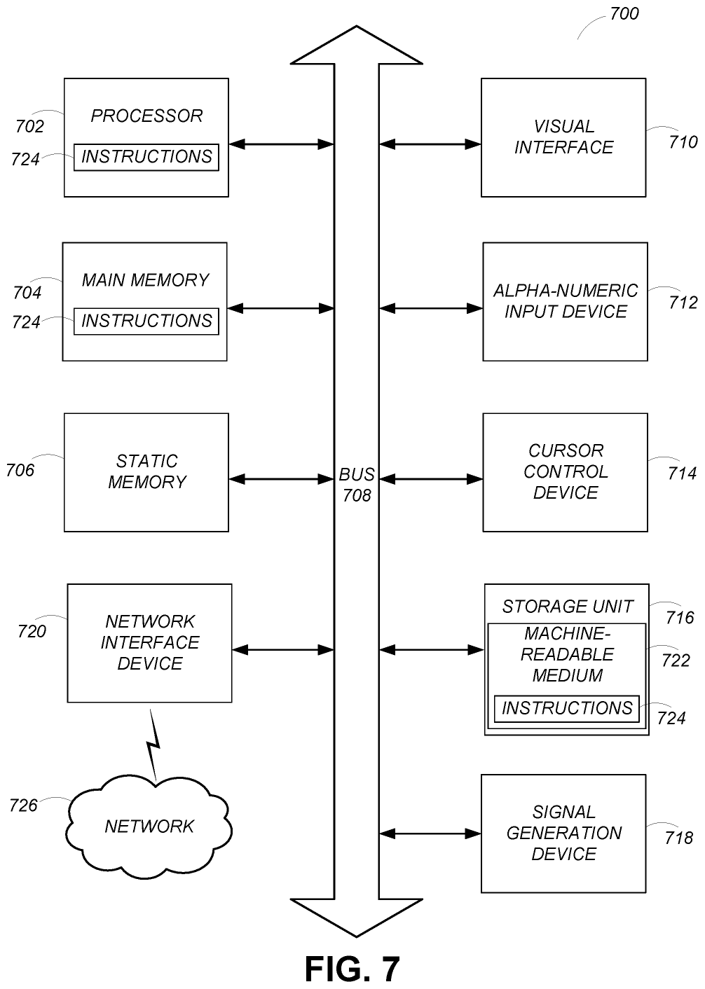

Client devices 110 and 111 are computing devices capable of receiving user input as well as transmitting and/or receiving data via a network (e.g., network 140). In some embodiments, client devices 110 and 111 are conventional computer systems, such as a desktop or a laptop computer. Alternatively, client devices 110 and 111 may be devices having computer functionality, such as a personal digital assistant (PDA), a mobile telephone, a smartphone, or another suitable device. Client devices 110 and 111 may be configured to communicate with offer selection optimizer system 120 via network 140, for example, using a native application executed by client device 110 or 111 or through an application programming interface (API) running on a native operating system of client device 110 or 111, such as IOS® or ANDROID™. In another example, the client devices 110 and 111 are configured to communicate with offer selection optimizer system 120 via an API running on system 120. Either client device 110 or 111 may be a computing device that includes the components of the machine depicted in FIG. 7.

Offer selection optimizer system 120 segments targeted users into persona segments and selects an optimal offer for a persona segment. System 120 includes persona selector 121, item categorizer 122, group divider 123, offer selector 124, weight generator 125, ranking module 126, user database 127, offer database 128, and feedback module 129. In some embodiments, system 120 includes additional, fewer, or different components for various functions. For example, user database 127 and/or offer database 128 may be stored remotely and accessible through network 140. In another example, an additional recommendation module may be included within offer selector 124 to calculate affinity scores of items within candidate offers considered for selection.

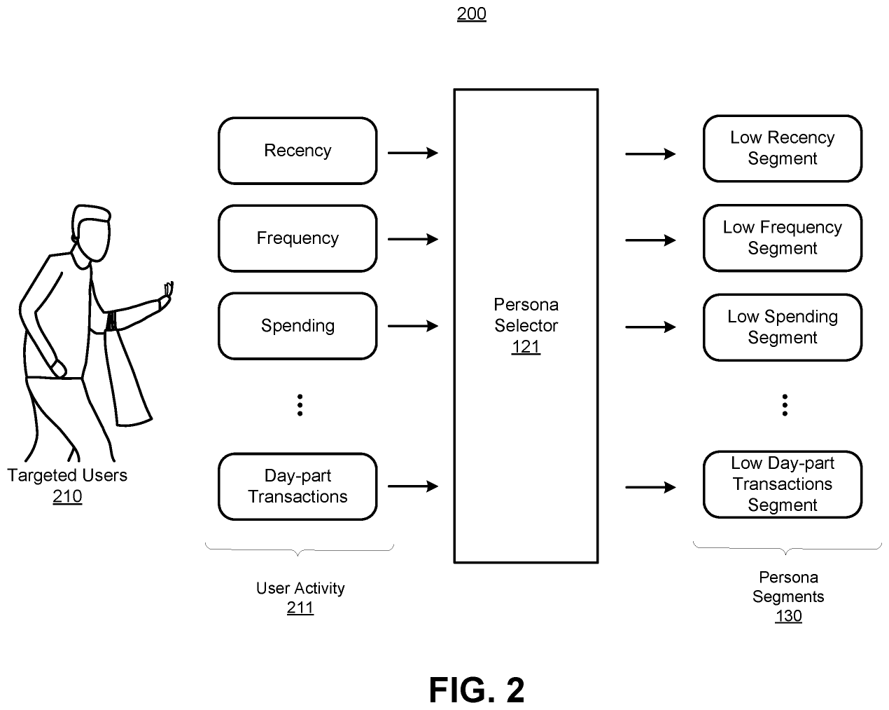

Persona selector 121 divides a pool of targeted users into persona segments. Targeted users are users of enterprises presenting offers selected by offer selection optimizer system 120. Although not depicted in FIG. 1, persona selector 121 receives a list of targeted users and the historical activity data of the targeted users. Activities described by the historical activity data may include but are not limited to when a targeted user last visited an enterprise (i.e., recency), the number of visits over a time period made by the targeted users (i.e., frequency), the average amount per purchase (i.e., spending), and times of day at which purchases were made (i.e., day-part transactions). The persona segments determined by the persona selector 121 may each be characterized by a key parameter. For example, targeted users whose activities indicate high spending but infrequent visits to an enterprise may be segmented into a persona segment characterized by a low frequency key parameter. Thus, a targeted user whose activity is characterized by a key parameter, which offer selection optimizer system 120 has identified as being influenceable, is segmented into a persona segment with another targeted user with similarly characterized activity. An example of the inputs and outputs of a persona selector is depicted in FIG. 2.

Persona selector 121 may optionally receive categories of items or a list of items from item categorizer 122. Using the item or item category list, persona selector 121 may output persona-item sub-segments. That is, persona selector 121 may further segment a persona segment based on the received item or item category list, dividing the targeted users in a persona segment based on an item or item category. For example, targeted users within a given persona-item sub-segment may be characterized by a key parameter and a shared preference for a given item or given item category. Persona selector 121 may access information regarding a preferred item or item category from customer database 127.

Persona segments may be created using statistical modeling, machine learning, rules-based algorithms, any suitable method for grouping user data based on similar key parameters, or a combination thereof. In some embodiments, persona selector 121 may train a machine learning model using training data labeled with respective persona segments. In one example of generating training data, persona selector 121 may generate feature vectors of each targeted user, where the dimensions of the vectors correspond to activity parameters (e.g., frequency, recency, spending, etc.). The feature vectors may be labeled by computer vision or manually with a key parameter (e.g., a “low frequency”). The labeled feature vectors may then be used to train a machine learning model to determine a likely persona segment to which a user and corresponding user activity belongs.

Persona selector 121 may apply a trained machine learning model to received targeted user data and output one or more persona segments grouping the targeted users by key parameters. The machine learning model may be subsequently retrained based on activity of the targeted users after an offer determined by offer selection optimizer system 120 has been presented to the targeted users. Although not depicted, feedback module 129 may provide user activity indicating that the performance of the offer selected influenced the behavior of targeted users towards a desired goal (e.g., increasing the frequency at which users segmented in a low frequency segment visit an enterprise). Using the provided user activity, persona selector 121 may retrain the machine learning model to strengthen an association between a low frequency segment and certain activities of targeted users included within previously used training data.

For example, feedback module 129 monitors user activity indicating a decrease in the frequency of visiting an enterprise for users who were segmented into a low frequency segment and who received offers selected for the low frequency segment. Based on this monitored activity, persona selector 121 may determine to weaken an association between the activities and “low frequency” label used to initially train the machine learning model that determined those users should belong in the low frequency segment. In weakening the association between the activities and the label, persona selector 121 decreases a likelihood with which the re-trained machine learning model will subsequently segment those users into the low frequency segment. Similarly, monitored activity may indicate an increase in the frequency of visits for users who were segmented in to the low frequency segment and persona selector 121 may strengthen an association between the users' activities and the “low frequency” label used to train the machine learning model. In strengthening the association between the activities and the label, persona selector 121 increases a likelihood with which the re-trained machine learning model will subsequently segment those users into the low frequency segment.

Offer selection optimizer system 120 may verify that the offer selection was optimized before determining to adjust the persona selection (e.g., retraining a machine learning model used by persona selector 121). For example, system 120 may determine that offers selected using an algorithm (e.g., a weighting function) similar to that used for the low frequency segment of the previous example was effective (e.g., a success rate above a threshold) for increasing the frequency of other users for visiting other enterprises.

By the monitoring the effect of selected offers to retrain a machine learning model that determines a likely persona segment for users, persona selector 121 improves the segmentation accuracy and thus, improves the efficacy of offers selected for the determined segment. In turn, persona selector 121 decreases the number of iterations of offer selection needed before the user-targeting achieves a desired objective. Thus, optimizing the segmentation through feedback further reduces the computing resources for selecting offers by reducing the number of future offer selection iterations needed.

Item categorizer 122 categorizes a pool of items offered by an enterprise to targeted users. Item categorizer 122 may receive a list of items and categorize the items based on information regarding the items and their sales such as price, items often purchased together, brand, any suitable descriptive parameter of an item or item sales, or a combination thereof. Item categorizer 122 may determine a particular category of items to prioritize. For example, item categorizer 122 may be configured to categorize a pool of items based on price or brand. Item categorizer 122 may prioritize categorizing based on price in response to a key parameter of interest (or lack thereof). In an example where persona selector 121 outputs one persona segment that was not characterizable by a single, key parameter, offer selection optimizer system 120 may determine that revenue should be maximized. In response, item categorizer 122 may provide the categorized items by price to persona selector 121 for persona-item sub-segmentation. This way, persona selector 121 may more efficiently identify an optimal offer for a persona-item sub-segment (e.g., with items that are relatively higher priced to produce a desired influence upon the sub-segment).

Group divider 123 divides persona segments created by persona selector 121 into two or more groups such that offer selection optimizer system 120 may evaluate the performance of offers provided among the groups. Group divider 123 receives persona segments or persona-item sub-segments from persona selector 121. The received segments are grouped based on an evaluation method (e.g., A/B testing). As referred to herein, the term “segment” may be used to refer to either a “persona segment” or “persona-item sub-segment” unless specified otherwise by context. Similarly, techniques applied to persona segments as described herein may be applied to persona-item sub-segments unless specified otherwise by context.

In one example, group divider 123 may, for each segment, split the segment into two groups—an exploitation group and an exploration group—for an A/B test. Group divider 123 may compare the number of targeted users in the segment against a threshold to determine how to split the users into two groups. If the number of targeted users is greater than the threshold, group divider 123 may use simple random sampling (SRS) to split the targeted users within a segment into two groups. If the number of targeted users is equal to or less than the threshold, group divider 123 may use stratified random sampling based on activity parameters characterizing the segment, which may include a key parameter of the segment. Group divider 123 outputs the created groups to offer selector 124 for one or more optimal offers to be provided to targeted users within respective groups.

Group divider 123 may be an optional component of system 120; offers may be selected for persona segments that are not divided into groups by group divider 123. That is, persona segments or persona-item sub-segments output from persona selector 121 may be directly input into offer selector 124 rather than into group divider 123. Although depicted in FIG. 1 as having two outputs corresponding to two groups of segments, group divider 123 may group a segment into more than two groups for output to offer selector 124.

Offer selector 124 generates optimal offers 131 for targeted users. Using information about targeted users and available offers, offer selector 124 determines one or more offers 131 to present to users segmented by persona selector 121. Offer selector 124 applies a weighting function to score offers. Each candidate offer's score may depend upon a persona segment, values of offer parameters associated with the candidate offer, weights of the offer parameters based on the persona segment, any suitable factor for influencing the score to be personalized to a persona segment or targeted user of the persona segment, or combination thereof. The highest scoring offer may be transmitted to a client device for presentation to a targeted user.

In some embodiments, offer scorer 124 ranks offer scores and selects offers based on a reorganized ranking of candidate offers. For example, offer scorer 124 may randomize the ranking of offers such that the highest scoring offer is not necessarily transmitted to a client device. These offers may be referred to herein as “exploration offers” that are used to explore the performance of offers that are not necessarily the most optimal (i.e., the most optimal being the highest scoring offer according to a weighting function). In some embodiments, offer scorer 124 modifies weights used in the weighting function to determine exploration offers to transmit to client devices. Offer selection optimization system 120 uses exploration offers to update the weighting function for subsequent offer selection.

Offer selector 124 may access databases 127 and 128 to generate optimal offers that are further personalized for targeted users. Offer selector 124 may access information about targeted users from user database 127. User database stores information about targeted users such as item preferences, location, age, brand preferences, price preferences, previous purchases, etc. Offer selection optimizer system 120 124 may store information related to user activity with an offer in user database 127. For example, system 120 may determine offer parameters (e.g., realized discount) of offers redeemed by a targeted user and store the offers parameters into a profile, in user database 127, associated with the targeted user. Offer selector 124 may access existing offers from offer database 128. The offers stored within offer database 128 may be created by enterprises or by offer selection optimizer system 120. Offers may be stored as data structure within offer database 128, where each data structure may include one or more of a list of items in the offer, a discount percentage (e.g., 20% reduced from the price of any item in the offer), a date range during which the offer is valid, a maximum number of times the offer may be redeemed by a single targeted user or multiple targeted users, or any suitable characteristic for providing an item for sale.

Offer selector 124 determines offer scores using a weighting function, where the weighting function may vary based on the persona segment for which an offer is being selected. In some embodiments, the weighting function is a linear combination of offer parameter values and offer parameter weights for a given persona segment and candidate offer. An example weighting function is illustrated in FIG. 4 and shown in Equation 1 below:

SegmentₛOfferₒScore=ΣᵢW_{s,i}*F(o)ᵢ (Eqn. 1)

where s is a persona segment, o is a historical offer, W_{s,i} is a weight of offer parameter i based on segment s, and F(o)ᵢ is a value of offer parameter i of offer o.

Offer selector 124 may determine offer parameter values for a candidate offer. Offer parameter values may include a qualification affinity score for the offer, a discounting affinity score for the offer, a realized discount value, and a gross spending value. Qualification affinity may refer to a targeted user's affinity for one or more items (e.g., before a reward such as a discount is given). A discount may be a bonus to an item with a high qualification because a targeted user may have been likely to purchase the item without the discount. Thus, the discount may be an incentive for a targeted user to purchase or explore additional items. This way, a high qualification affinity score may be an up-sell mechanism to incentivize a targeted user to explore an enterprise's catalog of items. This mechanism may be utilized in a strategy for targeting users who are associated with high recency or frequency activity parameters.

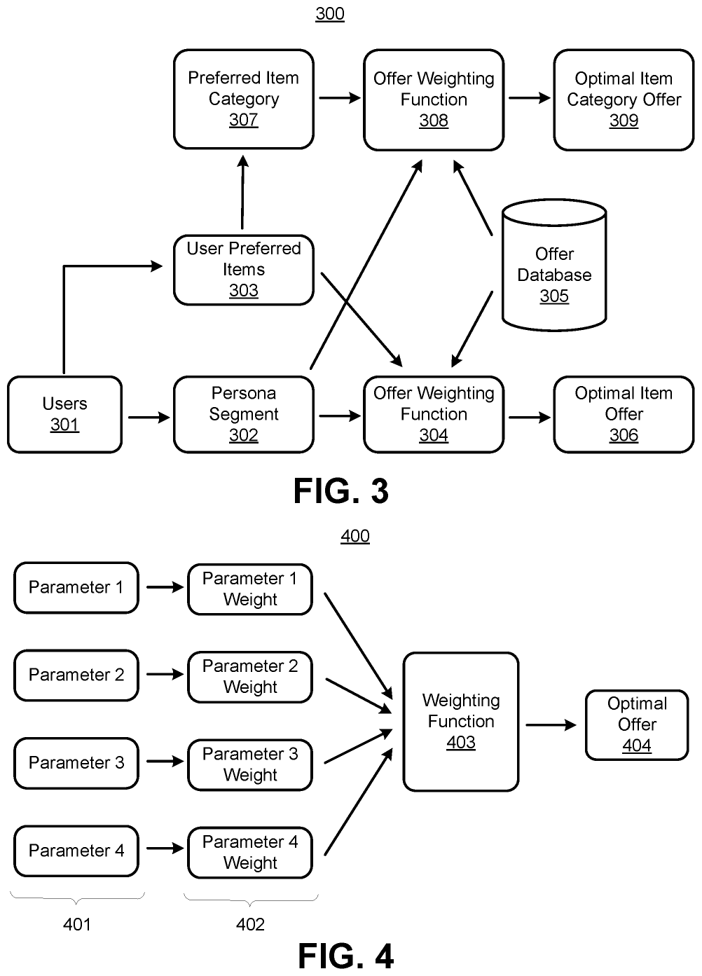

Discounting affinity may refer to a targeted user's affinity for discounts on the price of items. Targeted users who are characterized by activity indicating a high discounting affinity may be less influenced by items with a high qualification affinity score. A high discounting affinity may be associated with an activity parameter such as low spending. Offers characterized by high discounting affinity may be strategically selected for targeted users who are at risk for attrition. Offer selector 124 may determine an offer's qualification affinity score or discounting affinity score based on a manner in which offer selection optimization system 120 segments the targeted users. An example of affinity score determination based on segmentation is further described in the description of FIG. 3.

A realized discount value of an offer indicates an amount of discount obtained when the offer has been redeemed. The discount may be an absolute value (e.g., five dollars off a full price) or a percentage (e.g., a twenty percent discount). The discount value may be normalized to a value between 0.0 and 1.0 using min-max scaling, where the larger value indicates a higher discount value. In one example, offer selector 124 may determine an average realized discount value among items within an offer. In some embodiments, offer selector 124 may determine the complement of the realized discount value as an additional offer parameter (e.g., subtracting the realized discount value from 1.0). The complement of the realized discount value may be used target low discounts to users (e.g., whose activity indicates enterprise loyalty or high qualification affinity).

A gross spending value of an offer indicates the amount spent on a transaction for which the offer was redeemed. The gross spending value may be an average of total transaction amounts across each instance at which the offer was redeemed. The gross spending value may be normalized between 0.0 and 1.0 using min-max scaling. In some embodiments, the gross spending value includes items that were not included within the offer (e.g., items that were not discounted or part of a promotion). This way, the gross spending value may represent the effects of an offer on cross-selling, up-selling, or incentivizing additional users (e.g., an acquaintance of a targeted user who is not necessarily tracked by offer selection optimizer system 120) to make a transaction. Offers characterized by a high gross spending value may be strategically targeted to users whose activity indicates high loyalty with an enterprise.

Weight generator 125 determines the weights of offer parameters, where the weights are input by offer selector 124 to a weighting function. The initial weights output by weight generator 125 may be predetermined (i.e., specified by an administrator of system 120) based on a key parameter of a persona segment. For example, for a low spending persona segment, predefined weights for offer parameters may include a qualification affinity weight of 0.9 and a gross spending value weight of 0.1. In another example, for a low recency persona segment, a discounting affinity weight may be 0.7 and a realized discount value weight may be 0.3. In yet another, for a persona segment that is not characterized by a key parameter (i.e., there are no activity parameters that perform below target thresholds), predefined weights may include a qualification affinity weight of 0.9 and a gross spending value weight of 0.1. These weights are similar to the weight for a low spending persona segment, as a default strategy may be to increase the amount a target user spends.

Weight generator 125 may vary weights to generate offers that evaluate the performance of various offers for a persona segment. For example, during A/B testing, weight generator 125 may vary the offer parameter weights to determine exploration offers to transmit to client devices of targeted users grouped by group divider 123 into an exploration group. To determine a modified weight, weight generator 125 may determine an amount by which an initial weight (e.g., a predefined offer parameter weight for a persona segment) is to be modified. Weight generator 125 may determine a correlation between an offer weight value and impact upon a key parameter of a persona segment. For example, discounting affinity weights of 0.6, 0.7, and 0.8 may result in the rate at which an offer is redeemed increasing by 10%, 12%, and 13% respectively. Using the determined correlation, weight generator 125 may determine the amount by which the initial weight is to be modified. Continuing the previous example, weight generator 125 may use the determined correlation to determine an algorithm of 12%+α*0.01 to modify the discounting affinity weight, where a is a value between 0 and 1.

Ranking module 126 ranks offer scores (e.g., determined by a weighting function) for each candidate offer for a segment. For example, ranking module 126 may rank offer scores from smallest to greatest score, where the highest scoring offer is ranked highest and deemed the optimal offer. Offer selector 124 may provide the highest ranked offers for each segment to the targeted users in each corresponding segment. These offers are depicted in FIG. 1 as offers 131. Although not depicted, offers 131 are transmitted by offer selection optimization system 120 to client devices (e.g., client devices 110 and 111) over network 140. This is illustrated by a break in the arrows connecting offer selector 124 to feedback module 129 as depicted in FIG. 1.

In some embodiments, ranking module 126 may modify a previously determined ranking (e.g., smallest to greatest score). For example, ranking module 126 may randomly re-rank the previously determined ranking, reverse the ranking, modify the order of a portion of the ranking (e.g., modifying the order of offers within the top 10% of the ranking), or any suitable technique for modifying a ranking. Using the modified ranking, ranking module 126 may select the new highest ranked candidate offer or the newly top N-ranked offers to include in offers 131 for targeted users. Ranking module 126 may re-rank candidate offers to evaluate the performance of offers that may be less likely to be chosen (e.g., using the weighting function). For example, ranking module 126 may re-rank candidate offers for A/B testing, where one or more newly high ranking offers are provided to an exploration group. Offer selector 124 may use re-ranking, weight modification, or a combination thereof to determine offers to transmit to targeted users within an exploration group. FIG. 6 depicts an example process for generating offers for an exploration group using a weight generator and a ranking module.

Feedback module 129 tracks activity of the targeted users with the optimal offers. In some embodiments, feedback module 129 uses metrics to evaluate the tracked activity to determine the performance of offers 131. Feedback module 129 may track activity of targeted users before, during, and/or after a time at which an optimal offer is provided. Tracked activities may include visits to the enterprise at which the offer may be redeemed, transactions with the enterprise, an amount spent in the transactions, instances at which the offers are redeemed, any suitable interaction between a targeted user and an enterprise influenceable by an offer, or a combination thereof. Feedback module 129 may use various metrics to determine the success or failure of the transmitted offers. Metrics may include a number of visits, an average transaction size, total spending, offer redemption rate, recency, targeted user expansion, any suitable metric for evaluating the influence of an offer, or a combination thereof. Feedback module 129 may determine the value of a metric, which may then be used by offer selector 124 to update the process for selecting an optimal offer (e.g., updating the weights of the weighting function).

Network 140 may serve to communicatively couple client devices 110 and 111 and offer selection optimizer system 120. In some embodiments, network 140 includes any combination of local area and/or wide area networks, using wired and/or wireless communication systems. Network 140 may use standard communications technologies and/or protocols. For example, network 140 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of network 140 may be encrypted using any suitable technique or techniques.

### Offer Selection Using Persona Segmentation

FIG. 2 is a diagrammatic representation of persona segmentation determined by an offer selection optimizer system, in accordance with at least one embodiment. Offer selection optimization system 120 may access historical activity 211 of targeted users 210. Activity 211 of targeted users 210 may be characterized by activity parameters such as recency, frequency, spending, or day-part transactions. For example, a targeted user may visit an online store once a week, occasionally making large purchases relative to other targeted users visiting the sight. In this example, this targeted user's activity parameters may include a frequency activity parameter indicating their weekly visits and a spending activity parameter indicating an average amount spent in their transactions.

Persona selector 121 may receive activity 211 from an enterprise with which targeted users 210 interact. In some embodiments, activity 211 is tracked by the offer optimization system as described herein (e.g., via feedback module 129). For example, before, during, or after transmitting an optimal offer to a client device, the system may track a number of times a targeted user visits an enterprise, contributing to a frequency activity parameter, or the amount spent in a transaction during which the optimal offer was redeemed, contributing to a spending activity parameter.

Persona selector 121 may segment targeted users 210 based on an activity parameter that may be influenced (e.g., an enterprise wants to increase spending, frequency, and/or recency of users 210). In some embodiments, segmentation into persona segments may be rules based. The rules may include comparing activity parameters against thresholds. Offer selection optimizer system 120 may receive (e.g., from an enterprise) predefined activity parameter thresholds and compare a targeted user's activity against the received thresholds. This way, the system may determine one or more parameters that are underperforming against the threshold and determine an activity parameter to influence. The system may determine which of a user's activity parameters are the most below a corresponding activity parameter threshold and segment the user into a persona segment corresponding to the lowest performing activity parameter. For example, persona selector 121 determines that a targeted user is visiting an enterprise at 80% of the threshold frequency, but is spending at 50% of the threshold amount. While both activity parameters are performing below respective thresholds, persona selector 121 may segment the targeted user into a low spending segment because the spending activity parameter is performing relatively worse.

In some embodiments, as described in the description of FIG. 1, persona segmentation may be machine-learned. Persona selector 121 may include one or more machine learning models configured to receive, as input, user activity 211 of a targeted user, and determine a persona segment into which the targeted user is to be segmented. In addition to segmenting users into segments having a common key parameter, persona selector 121 may segment the users such that the values of other activity parameters are within a threshold range of other users' corresponding activity parameters. For example, two targeted users segmented into a low frequency segment may have recency activity parameters whose values are within a threshold of 10% of the maximum recency activity parameter. Persona selector 121 may determine targeted users who share a key parameter (e.g., low frequency) but whose other activity parameters are not similar (e.g., outside of threshold ranges). In response, persona selector 121 may determine an item or item category sub-segment into which the users may be further segmented. This way, offer selection optimizer system 120 may improve the likelihood that optimal offers selected for the differently behaving users. Alternatively, persona selector 121 may still proceed to segment the users into the same low frequency segment.

Although not depicted, targeted users may be segmented, in addition or alternatively to being segmented by key parameters, by demographic information. Furthermore, the persona segments can be further segmented by item or item category. For example, targeted users in the low frequency segment may be sub-segmented into targeted users who have a high affinity towards a given item category (e.g., pet supplies, cosmetics, recreational equipment, etc.). The same item or item category may be used to segment users within different persona segments. For example, a user in a low spending segment may be segmented into a low spending, pet supply sub-segment and a user in a low frequency segment may be segmented into a low frequency, pet supply sub-segment.

FIG. 3 depicts a block diagram of offer selection processes 300 using an offer selection optimizer system, in accordance with at least one embodiment. Processes 300 may be performed by offer selection optimization system 120. In alternative configurations, different and/or additional components may be included in processes 300. For example, a database (e.g., user database 127) storing users' item preferences for determining an offer may be included. Two example processes for selecting an optimal offer based on persona segment are depicted in processes 300. In one process, offer weighting function 304 is used at a granularity of segmentation based on persona segment 302 to select optimal item offer 306. In a second process, offer weighting function 308 is used at a finer granularity of segmentation based on persona-item sub-segment (e.g., based on preferred item category 307) to select optimal item category offer 309.

For each process, offer selection optimization system 120 accesses activity parameters characterizing activity of targeted users 301. A targeted user is segmented into persona segment 302 (e.g., a low recency segment). For each targeted user in segment 302, qualification and discounting affinity scores of one or more preferred items of the targeted user are calculated. These scores may be used to determine qualification and discounting affinity scores of a candidate offer that includes the preferred items. The affinity scores of each item within an offer may be calculated by a third party or by a recommendation algorithm at system 120.

Further, for each process, offer selection optimizer system 120 accesses candidate offers from offer database 305. For example, a candidate offer accessed from offer database 305 includes items such as clothing and accessories. To increase the recency of the targeted user for the enterprise offering the clothing and accessories in the candidate offer, system 120 may apply a larger weight to offers with greater discounts. This may translate algorithmically to using a higher weight in the weighting algorithm for the discounting offer parameter of candidate offers. Depending on the segmentation granularity used, offer parameter values may differ for the same candidate offer scored using a weighting function. Because of the differing offer parameter values, offer weighting function 308 and 304 are labeled using different reference numerals although the same function (e.g., Equation 1) may be used to score candidate offers. The process for system 120 to obtain different offer parameter values depending on segmentation is explained further below.

In a first process of processes 300 for selecting optimal item offer 306, offer selection optimizer system 120 uses the activity of users 301 to segment users into persona segments. Persona segment 302 and preferred items 303 of a targeted user within persona segment 302 are used in offer weighting function 304. Persona segment 302 may be obtained using persona selector 121. User preferred items 303 may be obtained from user database 127. Offer weighting function 304 may be a linear combination of offer parameters and corresponding weights, where the values of the offer parameters and corresponding weights may depend on either the key parameter of persona segment 302 or preferred items 303. Using one or more of preferred items 303, offer selection optimizer system 120 determines offer parameter values used in offer weighting function 304 to calculate scores for candidate offers. Offer parameters may include qualification affinity of items within the offer, discounting affinity of items within the offer, discount rate, and gross spending.

In this first process, offer selection optimizer system 120 determines a representation of the qualification and discounting affinity scores of one or more preferred items of a targeted user of users 301 to serve as the respective qualification affinity score and discounting affinity score of an offer including the individual items. For example, system 120 may average the qualification affinity score of each item within an offer for each user in persona segment 302 to obtain the offer's qualification affinity score. Although system 120 may use the affinity scores of each item within the offer, this calculation may be processing intensive. In some embodiments, system 120 may determine, for each user, the top scoring item for the qualification affinity score and the top scoring item for the discounting affinity scores. Using the top scoring items for each user, system 120 may determine a threshold range of items to average to represent the qualification and discounting affinity scores for the offer. For example, system 120 may average the top 10% of items' discounting affinity scores to obtain the offer's discounting affinity scores. This way, although the representation of the items' qualification affinity scores may not account for each item in an offer, system 120 has optimized for processing resources while achieving a personalized representation of the qualification affinity score by accounting for the scores of items having highest affinity scores for targeted users. The highest scoring offer as determined by offer weighting function 304 may be selected as optimal item offer 306.

In a second process of processes 300 for selecting optimal item category offer 309, the activity of users 301 is used to segment users into persona segments, which is further segmented into a persona-item sub-segment based on the item preferences of users 301. Persona segment 302 and preferred item category 307 of a targeted user within persona segment 302 are used in offer weighting function 304. In segmenting persona segment 302 by preferred items 303, offer selection optimizer system 120 may achieve additional personalization within a sub-segment than within a persona segment. This additional personalization based on items may be achieved by categorizing preferred items 303 and determining an offer that includes a threshold number of items within preferred item category 307. Thus, the second process determines optimal item category offer 309, termed as such to refer to the influence of item categories in the offer selection.

Preferred item category 307 may be obtained from user database 127. Offer weighting function 308 may be a linear combination of offer parameters and corresponding weights, where the values of the offer parameters and corresponding weights may depend on either the key parameter of persona segment 302 or preferred items 303. Candidate offers having a threshold number of items belonging to a target user's preferred item category are evaluated using offer weighting function 308. Offer selection optimizer system 120 may use the value of the qualification affinity score and discounting affinity score of the targeted user's most preferred item within a candidate offer as the candidate offer's qualification affinity score and discounting affinity score, respectively. The highest scoring offer as determined by offer weighting function 308 may be selected as optimal item category offer 309.

For both the first and second processes, offer selection optimizer system 120 may determine values of offer parameter weights based on the key parameter of persona segment 302 using techniques as described in the description of FIG. 1. System 120 may calculate values of other offer parameters such as discount value and gross spending based on previous instances when the corresponding candidate offer was redeemed. For example, system 120 calculates the value for a candidate offer's gross spending offer parameter by averaging the amount spent during transactions in which the candidate offer was redeemed.

FIG. 4 illustrates a block diagram of offer weighting function 400 used to select optimal offer 404 for a persona segment, in accordance with at least one embodiment. Although four pairs of parameters 401 and weights 402 are depicted for clarity, additional or fewer parameter and weight pairs may be input into weighting function 403. The offer selection optimizer system described herein may use weighting function 403 to determine optimal offer 404. Weighting function 403 may be represented by Equation 1.

Offer selection optimizer system 120 may select optimal offers through a linear combination of a candidate offer's offer parameters 401 with corresponding weights 402, where the values of weights 402 may depend on the persona segment targeted by system 120. Depending on an activity parameter that is desired (e.g., by an enterprise) to be influenced for targeted users segmented into a persona segment, where this parameter is referred to as a “key parameter,” system 120 may select different weights for each offer parameter 401. For example, targeted users who are lacking in recency may need a relatively large discount to revisit an enterprise. Therefore, system 120 may target these users with an offer having a large discount rate using the following weights: discounting affinity weight of 70% and realized discount weight of 30%. In another example for a persona segment which has no lacking activity parameter (i.e., no activity parameter is performing below a target performance threshold), the system may determine a set of weights designed to increase revenue from targeted users while keeping them interested: qualification affinity weight of 90% and realized gross spending weight of 10%.

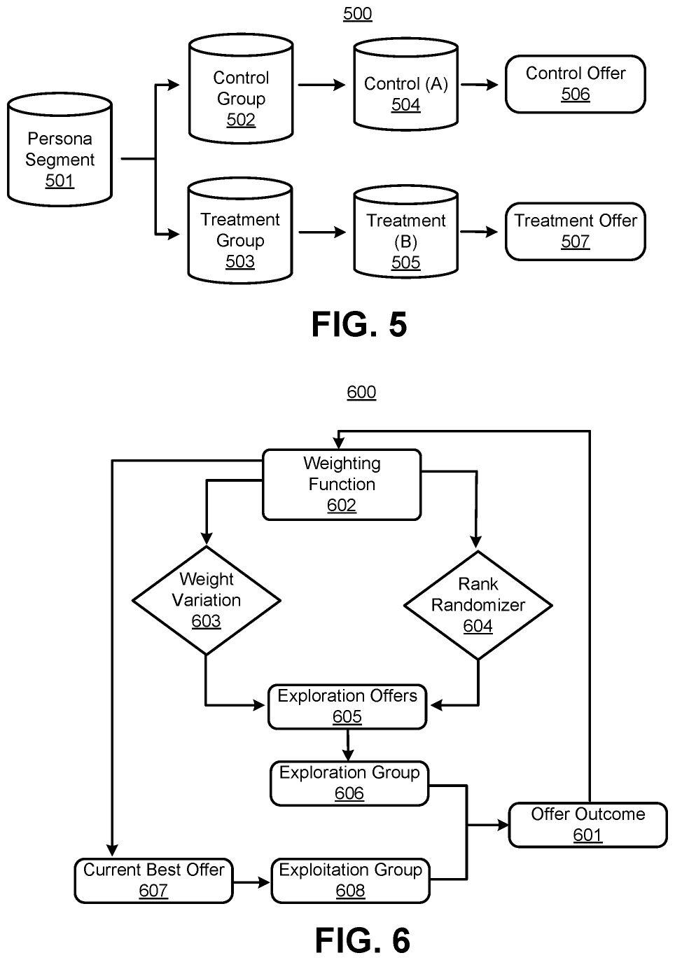

FIG. 5 depicts a block diagram of performance data generation 500 through groupings of persona segment 501, in accordance with at least one embodiment. In some embodiments, performance data generation 500 is performed by offer selection optimizer system 120 using A/B testing. The testing enables system 120 to measure the success of offers selected by system 120. System 120 may determine control group 502, or “exploitation group,” and treatment group 503, or “exploration group,” into which targeted users within persona segment 501 are grouped into (e.g., by group divider 123). Users within control group 502 may receive an offer as selected by standard operation of system 120 for an optimal offer. Users within treatment group 503 may receive one or more offers that are selected by altered operations of system 120 (i.e., not necessarily the optimal offer).

Offer selection optimizer system 120 may determine control group 502 and treatment group 503 such that the users of persona segment 501 are fairly assigned to either group. In one example process, system 120 may determine a number of users that should be in each of the control group 502 and treatment group 503. That is, system 120 may determine optimal sizes for groups 502 and 503 such that there is a minimum number of targeted users in each group for the A/B testing to show statistical significance given a predicted effective size and confidence level. System 120 may organize users within treatment group 503 based on items or item categories of candidate offers (e.g., based on a user's preferred item category).

System 120 may assign users of persona segment 501 into either group 502 and 503 based on the number of users within segment 501. If the segment is larger than a predefined threshold, system 120 uses simple random sampling (SRS) to split the users into groups 502 and 503. If the segment is equal to or less than the predefined threshold, system 120 uses stratified random sampling based on one or more activity parameters characterizing segment 501, which may include the key parameter of segment 501. System 120 may increase the fairness of the groups to which users are assigned by determining groups that are characterized similarly by one or more activity parameters. For example, system 120 may determine a distribution between two groups among three activity parameters of recency, frequency, and predicted future 90-day spending, where users in the two groups behave similarly (e.g., the users' spending predictions are within a threshold range of each other) according to those three activity parameters. In some embodiments, system 120 determines that the distribution according to the one or more activity parameters are not similar (e.g., values of corresponding activity parameters are not within respective threshold ranges) and may perform stratified random sampling again until the groups are characterized similarly by the one or more activity parameters.

Offer selection optimizer system 120 may determine various operations to perform with control group 502. In a first example, system 120 performs business-as-usual (BAU). This enables system 120 to compare the current operation of system 120 for group 502 against an alternative operation for group 503. In a second example, system 120 transmits a notification to a client device, where the notification includes a reminder that the user revisit an enterprise. System 120 may then compare alternative operations for group 503 against the effects of the reminder sent to group 502. In a third example, system 120 transmits a generic notification to a client device, where the notification includes information relating to an optimal offer, and thus, personalized offer, as selected using BAU operations. In a fourth example, system 120 generates a generic offer with the same discount as an optimal offer to provide to a client device. In the fourth example, system 120 may compare alternative operations for group 503 against an offer provided to group 502 that is a superset of the optimal, personalized offer. In some embodiments, system 120 may perform any combination of the aforementioned operations with control group 502. These operations are denoted in FIG. 5 as Control (A) 504. Control offer 506 may be the BAU offer or generic offer determined for control group 502.

Offer selection optimizer system 120 may determine alternative operations, denoted as Treatment (B) 505, to perform with treatment group 503. Alternative operations refer to the selection of an offer that does not necessarily result in an optimal offer. An optimal offer may be selected using a weighting function with weights that have been optimized using a feedback mechanism or predefined to be optimal. In some embodiments, to select an offer that is not necessarily optimal, system 120 may modify the weights to obtain weights that have not yet been shown to increase the performance of a key parameter for the persona segment or the user in the persona segment. This resultant offer selected based on modified weights may be treatment offer 507 presented to treatment group 503. In some embodiments, system 120 may modify a ranking of candidate offers such that the highest ranking offer is not the candidate offer having the highest score as determined by a weighting function. This new highest ranking offer may be treatment offer 507 selected for presentation with treatment group 503.

The success of A/B testing performed by offer selection optimizer system 120 can be measured through various metrics. System 120 may track the activities of users within groups 502 and 503 before, during, and/or after the presentation of offers 506 and 507, respectively. System 120 may use various metrics for evaluating the performance of offers 506 and 507 and determine the success of offer 507 by comparing performance of offer 507 against the performance of offer 506. Metrics may include a number of visits by a targeted user to an enterprise, average check size or amount spent in a transaction, total spending, redemption rate or the frequency at which an offer is redeemed, and a long-term customer value. The long-term customer value may be determined based on an extended post-campaign study of the activities of targeted users. System 120 may track activities such as visiting an enterprise after the offer has expired to determine a long-term customer value.

FIG. 6 depicts a block diagram of optimization process 600 for offer weighting function 602 used to select an offer, in accordance with at least one embodiment. Process 600 may be performed by offer selection optimizer system 120. Weights in function 602 may be initially predetermined and updated as system 120 monitors user activity with selected offers. Performance data is obtained from tracking activities of targeted users and used to update the weights. Process 600 shows the generation of exploration offers 605, using weight variation 603 and/or rank randomizer 604, for exploration group 606, where the activities of exploration group 606 can be compared against the activities of exploitation group 608 to determine performance data, which includes offer outcome 601.

Offer selection optimizer system 120 may select one or more exploration offers 605 different from current best offer 607 selected by a current weighting function 602 (e.g., a weighting function with initial, predefined weights). System 120 may present exploration offers 605 to a small (e.g., 10% of users within a persona segment) group of targeted users. Exploration offers 605 may be selected by altering current weighting function 602 to several variations of weighting functions in a controlled, stepwise manner. For example, current weighting function 602 weighs a discounting affinity offer parameter at 70%. The variation for this parameter for selecting exploration offers 605 could be 60% to 80% with 5% as a step.

In some embodiments, exploration offers 605 may be selected by assigning selection probabilities to offers in a ranking of offers according to the scores determined by weighting function 602. Offer selection optimizer system 120 may use selection probabilities in place of exclusively selecting the top scored offer. In some embodiments, to generate exploration offers 605, system 120 may remove the top scored offer from the ranking. For example, system 120 assigns the selection probabilities to be 0%, 50% and 50% for the first, second, and third highest scoring offers, respectively, as determined by the current weighting function 602.

Offer selection optimizer system 120 may select targeted users of a persona segment for exploration group 606 using the process for assigning users to control and treatment groups as described in the description of FIG. 5 such that targeted users are fairly distributed into either exploration group 606 or exploitation group 608. System 120 uses exploration offers 605 and current best offer 607 to gather performance data related to user activity across various iterations of weighting functions (e.g., through modified weights) and therefore, can determine a model of a controlled trajectory of weighted offer parameters against offer outcomes 601. The interpolation of the model enables system 120 to optimize a direction of weighted parameters for the desired target outcome. System 120 may determine a rate at which a weight is modified with each iteration of modifying weights based on offer outcomes 601. For example, if the discounting affinity parameter has a weight of 60%, 70%, and 80% in respective iterations of selecting offers that result in the redemption rate of the offers as 10%, 12% and 13%, respectively, system 120 may increase the weight for the discounting affinity parameter at a subsequent iteration.

Through the monitoring the effect of selected offers and optimizing the weights used to select subsequent offers, optimization process 600 decreases the number of iterations of selecting offers that offer selection optimizer system 120 may need to determine and transmit before the user-targeting achieves a desired objective (e.g., increasing an amount spent by users each visit to an enterprise). Thus, optimizing the selection through feedback further reduces the computing resources for selecting offers by reducing the number of future offer selection iterations needed.

### Computing Machine Architecture

FIG. 7 shows a diagrammatic representation of an example computer system for implementing an offer selection optimizer system, in accordance with at least one embodiment. Specifically, FIG. 7 shows a diagrammatic representation of a machine in the example form of a computer system 700 within which program code (e.g., software) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 710 may include or may interface with a touch enabled screen. The computer system 700 may also include alphanumeric input device 712 (e.g., a keyboard or touch screen keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storⁱng instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### An Example Process for Selecting an Offer

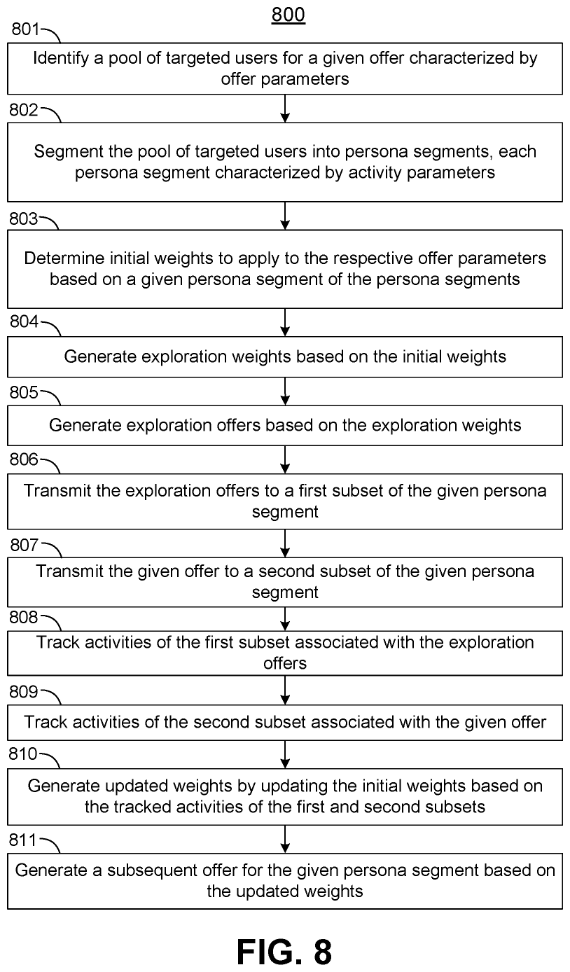

FIG. 8 is a flowchart illustrating process 800 for selecting an offer, in accordance with at least one embodiment. In some embodiments, offer selection optimizer system 120 performs operations of process 800 in parallel, in different orders, or perform different steps. For example, tracking 808 and 809 activities of subsets of targeted users given different offers may be performed in parallel. In another example, although not depicted, targeted users within a persona segment may be grouped into a control group and a treatment group (i.e., an “exploration group”).

An offer selection optimizer system identifies 801 a pool of targeted users for a given offer, where the offer is characterized by offer parameters. In some embodiments, a pool of targeted users have interacted with an enterprise previously, where interactions include visiting the enterprise (e.g., online or at a brick and mortar store), sharing preferences for certain items sold by the enterprise (e.g., via a user profile), purchasing items provided for sale by the enterprise, or redeeming offers made by the enterprise for discounted items. The system may receive information about the targeted users from the enterprise, where the information describes such interactions and may be characterized by activity parameters as described herein (e.g., frequency, recency, spending, etc.). The enterprise may provide the system with information regarding existing offers available for selection and providing to the targeted users. The system may identify 801 one of the users who have previously interacted with the enterprise or a user who has not yet interacted with this enterprise but has interacted with a similar enterprise. The system may determine that another enterprise is similar based on information regarding the items sold (e.g., price, brand, purpose, etc.). The identified users may be presented an offer from the enterprise.

In one example, the system identifies a pool of targeted users for an offer by an enterprise selling items for recreational activities (e.g., equipment for sports, exercise apparel, food and drinks for post-exercise, etc.). The offer may be characterized by offer parameters such as qualification affinity of the offer, the discounting affinity of the offer, the discount amount of the offer, and the gross spending amount realized with past instances that the offer has been redeemed. The system may determine the qualification affinity and/or discounting affinity of the offer after segmenting 802 the users into persona segments, as the affinities may be dependent upon the persona segment and/or the item preferences of the users within the persona segment.

Continuing the previous example, the system may determine a qualification affinity score for each item in an offer based on the activities of a particular user (e.g., the user's likelihood of purchasing a bicycle without a discount). The system may additionally or alternatively determine a discounting affinity score for each item in the offer based on the particular user's activities (e.g., the user's likelihood of purchasing the bicycle if the bicycle is discounted). The system may determine a discount amount of the offer (e.g., cycling equipment is 30% off). The system may determine a gross spending amount realized when offers have been redeemed (e.g., a previous user spent $550 in a transaction that included a purchase for an item qualifying under the offer, where the discount from the offer is not captured in the gross spending amount).

The offer selection optimizer system segments 802 the pool of targeted users into persona segments. Each persona segment may be characterized by activity parameters. A key parameter may be associated with each persona segment and drive the selection of the optimal offer. Continuing the previous example, targeted users may be segmented into a low spending segment and a low recency segment. Activity of users within the low spending segment may be characterized by a spending activity parameter reflective of relatively low spending (e.g., spending amounts in the lower 20% of all users visiting the enterprise), where the spending activity parameter is the key parameter of the low spending segment. That is, the spending behavior of the users may be influenced in a direction desired by the enterprise (e.g., an offer may be selected to influence the users to increase their spending). Activity of users within the low spending segment may also be characterized by other parameters such as a frequency activity parameter, recency activity parameter, etc. Activity of users within the low recency segment may be characterized by a recency activity parameter reflective of a relatively large amount of time since the users last visited the enterprise. Activity of users within the low recency segment may also be characterized by other parameters such as a frequency activity parameter, spending activity parameter, etc.

The offer selection optimizer system determines 803 initial weights to apply to the respective offer parameters based on a given persona segment of the persona segments. The system may receive weights from an enterprise that are predetermined, by the enterprise, for specific persona segments. Continuing the previous example, the enterprise selling recreational activity items may provide the offer selection optimizer system with a first set of predetermined weights for the low spending segment and a second set of predetermined weights for the low recency segment. The first set of weights may include a weight of 60% for the gross spending offer parameter, 30% for the qualification affinity offer parameter, and 10% for the discounting affinity offer parameter. This predetermined set of weights may have been determined by the offer selection optimizer system as driving users to increase their spending, and the system recommends this set of weights as a default for the enterprise. The second set of weights may have values intended to attract users to revisit the enterprise. The system may determine an optimal offer based on the initial weights. This optimal offer may be presented to a control group (e.g., during A/B testing).

The offer selection optimizer system generates 804 exploration weights based on the initial weights. The system may modify weights randomly or based on performances of similar offers for similar persona segments. For example, the system may have determined, for a similar enterprise, a model of a controlled trajectory of weighted offer parameters against offer outcomes. The system may use the model to determine a modification for the weights for offers of the present enterprise offering recreational activity items (e.g., if the system has not generated a model for the present enterprise based on the performance of the enterprise's offers).

The offer selection optimizer system generates 805 exploration offers based on the exploration weights. The system may apply the generated 804 exploration weights in a weighting function such as Equation 1. Continuing the previous example, candidate offers of the recreational activity enterprise may be evaluated for each user within the low recency segment and each user within the low spending segment. The offer scoring from the linear combination of offer parameter values for each user and the generated 804 exploration weights may be different from the offer scoring produced by the determined 803 initial weights. The different scores for candidate offers may result in a new, highest scoring offer that the system selects to transmit 806 to a targeted user's client device. The offers that are not determined to be the highest scoring based on BAU practices may be referred to herein as “exploration offers.”

The offer selection optimizer system transmits 806 the exploration offers to a first subset of the given persona segment. In some embodiments, the system may determine two or more exploration offers to transmit 806 to an exploration group rather than one exploration offer. Continuing the previous example, while an optimal offer selected for a subset of users in the low spending segment may include a bicycle that has a high qualification affinity score among the subset of users, various exploration offers relating to scooters, skateboards, or rollerblades with lower qualification affinity scores than the optimal offer may be presented to the subset of users to evaluate the exploration offers' performances. The generated 804 exploration weights may contribute to the system selecting these alternative offers as the exploration offers (e.g., the weight for realized discount value was increased, which caused the offer scores for the alternative offers to increase over the optimal offer).

The offer selection optimizer system transmits 807 the given offer to a second subset of the given persona segment. The given offer may be the highest scoring offer as determined by a weighting function using the initial weights. Continuing the previous example, the system may determine that the given offer is for a bicycle, and transmits the bicycle offer to a subset of targeted users in the low spending segment.

The offer selection optimizer system tracks 808 activities of the first subset associated with the exploration offers. The system may track activities before, during, and/or after the exploration offers are is transmitted 806 to the first subset of users of the given persona segment. Continuing the previous example, the system may track the size of transactions made by the first subset of targeted users with the enterprise before the exploration offers are transmitted 806 and track the size of transactions made after the exploration offers are transmitted 806.

The offer selection optimizer system tracks 809 activities of the second subset associated with the given offer. Similar to the tracking 808 of activities of the first subset of users, the system may track activities before, during, and/or after the given offer is transmitted 807 to the second subset of users of the given persona segment. Continuing the previous example, the system may track transaction sizes before and after the given offer is transmitted.

The offer selection optimizer system generates 810 updated weights by updating the initial weights based on the tracked activities of the first and second subsets. The system may generate 810 the updated weights based on the performance of the exploration offers and the given offer. For example, the system uses the tracked 808 and 809 activities to determine the performance of the exploration offer compared to the performance of the given offer. Continuing the previous example, the system may compare the transaction sizes of targeted users within the first and second subsets after the respective offers were transmitted 806 and 807. The system may additionally or alternatively compare the difference between transactions made by the first subset before and after the exploration offers were transmitted against the difference between transactions made by the second subset before and after the given offer was transmitted. The system may create a model to estimate the trajectory of offer parameter weights against offer performance. Continuing the previous example, the system may use this model to estimate the performance of an offer with users in the low spending segment.

The offer selection optimizer system generates 811 a subsequent offer for the given persona segment based on the updated weights. To generate 811 the subsequent offer, the system may determine an offer from existing offers or generate a new offer by determining one or more items to be included within an offer, a discount rate to apply to the included items, an expiration time for the offer, etc. The subsequent offer may be the same as the given offer (e.g., despite generating updated weights, the weighting function continues to determine that the highest scoring offer is the given offer) or a different offer. Continuing the previous example, the system may apply the updated weights to the weighting function used to generate the optimal offer with the bicycle for the users in the low spending segment. The newly generated weights may reflect that the targeted users spent more in a transaction for a discounted scooter than for a non-discounted bicycle. Accordingly, the result of the weighting function may produce a subsequent, optimal offer for the users in the low spending segment that includes a discounted scooter.

### Additional Configuration Considerations

Example benefits and advantages of the disclosed configurations include optimizing processing resources required to select personalized offers for targeted users. By implementing segmentation by persona and optionally, sub-segmentation by item, the offer selection optimizer system described herein may use less processing resources than selecting an offer at an individual user scale. Further, the system is able to maintain a level of personalization for selected offers due to the granularity of the segments. The system improves the selection of personalized offers using performance evaluation techniques such as A/B testing for users at the segment-level. For example, users within the same segment are assigned to control and treatment groups for A/B testing. Thus, the feedback obtained from A/B testing may be more tailored than feedback obtained from assigning users to groups regardless of segment.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for optimizing offer selection based on segmentation through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
identifying a pool of targeted users for a given offer characterized by a plurality of offer parameters;
segmenting the pool of targeted users into a plurality of persona segments, each persona segment characterized by a plurality of activity parameters;
determining a plurality of initial weights to apply to the respective plurality of offer parameters based on a given persona segment of the plurality of persona segments;
generating a plurality of exploration weights based on the plurality of initial weights;
generating a plurality of exploration offers based on the plurality of exploration weights;
transmitting the plurality of exploration offers to a first subset of the given persona segment;
transmitting the given offer to a second subset of the given persona segment;
tracking a first plurality of activities of the first subset associated with the plurality of exploration offers;
tracking a second plurality of activities of the second subset associated with the given offer;
generating a plurality of updated weights by updating the plurality of initial weights based on the first plurality of activities and the second plurality of activities; and
generating a subsequent offer for the given persona segment based on the plurality of updated weights.

2. The method of claim 1, further comprising:
identifying a pool of content items, the given offer applicable for a subset of the pool of content items;
segmenting the pool of content items into a plurality of content item segments; and
segmenting, based on the plurality of content item segments, targeted users of the given persona segment into a plurality of sub-segments of targeted users, and
wherein the generated subsequent offer is for a sub-segment of the plurality of sub-segments of targeted users.

3. The method of claim 2, wherein the first subset and the second subset are segmented into the same content item segment.

4. The method of claim 2, further comprising generating the given offer by, for each targeted user of the first subset, and for each candidate offer of a plurality of candidate offers:
determining, based on a content item segment of the plurality of content item segments, a preferred content item of the candidate offer, the preferred content item associated with a qualification affinity score and a discounting affinity score; and
calculating an offer score for the candidate offer based on a linear combination of the qualification affinity score, the discounting affinity score, and the plurality of initial weights.

5. The method of claim 1, further comprising:
accessing a plurality of candidate offers from a database of historical offers, wherein each candidate offer is applicable for a plurality of content items, each content item of the plurality of content items associated with an item qualification affinity score and an item discounting affinity score;
determining, for each candidate offer of the plurality of candidate offers, an offer score by:
determining a representative qualification affinity score based on a plurality of item qualification affinity scores each greater than or equal to a threshold qualification affinity score;
determining a representative discounting affinity score based on a plurality of item discounting affinity scores each greater than or equal to a threshold discounting affinity score; and
calculating the offer score based on a linear combination of the representative qualification affinity score, the representative discounting affinity score, and the plurality of initial weights; and
generating the given offer based on a candidate offer having the highest offer score of the plurality of offer scores of the plurality of candidate offers.

6. The method of claim 1, further comprising generating the first subset and the second subset by:
comparing the size of the given persona segment against a threshold size;
in response to determining that the size of the given persona segment is greater than or equal to the threshold size, splitting the given persona segment into the first subset and the second subset using simple random sampling; and
in response to determining that the size of the given persona segment is less than the threshold size, splitting the given persona segment into the first subset and the second subset using stratified random sampling based on an activity parameter characterizing the given persona segment.

7. The method of claim 1, wherein the plurality of offer parameters include one or more of a qualification affinity, discounting affinity, average realized discount rate, or an average gross spending.

8. The method of claim 1, wherein generating the plurality of exploration offers comprises:
determining a rank of candidate offers associated with the given persona segment;
modifying the rank of the candidate offers associated with the given persona segment; and
selecting the plurality of exploration offers from a subset of the candidate offers above a predetermined ranking in the modified rank.

9. The method of claim 1, wherein the plurality of initial weights are predetermined based on the given persona segment.

10. The method of claim 1, wherein the first plurality of activities are characterized by one or more of a frequency of visits to a location where the given offer may be redeemed, an amount spent at the location, a number of times the given offer is redeemed, or a visit to the location after the given offer has expired.

11. A system comprising:
a persona selector configured to:
identify a pool of targeted users for a given offer characterized by a plurality of offer parameters; and
segment the pool of targeted users into a plurality of persona segments, each persona segment characterized by a plurality of activity parameters;
an offer selector configured to:
determine a plurality of initial weights to apply to the respective plurality of offer parameters based on a given persona segment of the plurality of persona segments;
generate a plurality of exploration weights based on the plurality of initial weights;
generate a plurality of exploration offers based on the plurality of exploration weights;
transmit the plurality of exploration offers to a first subset of the given persona segment; and
transmit the given offer to a second subset of the given persona segment; and
a feedback module configured to:
track a first plurality of activities of the first subset associated with the plurality of exploration offers; and
track a second plurality of activities of the second subset associated with the given offer, and
wherein the offer selector is further configured to:
generate a plurality of updated weights by updating the plurality of initial weights based on the first plurality of activities and the second plurality of activities; and
generate a subsequent offer for the given persona segment based on the plurality of updated weights.

12. The system of claim 11, further comprising an item categorizer configured to:
identify a pool of content items, the given offer applicable for a subset of the pool of content items;
segment the pool of content items into a plurality of content item segments; and
segment, based on the plurality of content item segments, targeted users of the given persona segment into a plurality of sub-segments of targeted users, and
wherein the generated subsequent offer is for a sub-segment of the plurality of sub-segments of targeted users.

13. The system of claim 12, wherein the offer selector is further configured to generate the given offer by, for each targeted user of the first subset, and for each candidate offer of a plurality of candidate offers:
determining, based on a content item segment of the plurality of content item segments, a preferred content item of the candidate offer, the preferred content item associated with a qualification affinity score and a discounting affinity score; and
calculating an offer score for the candidate offer based on a linear combination of the qualification affinity score, the discounting affinity score, and the plurality of initial weights.

14. The system of claim 11, wherein the offer selector is further configured to:
access a plurality of candidate offers from a database of historical offers, wherein each candidate offer is applicable for a plurality of content items, each content item of the plurality of content items associated with an item qualification affinity score and an item discounting affinity score;
determine, for each candidate offer of the plurality of candidate offers, an offer score by:
determining a representative qualification affinity score based on a plurality of item qualification affinity scores each greater than or equal to a threshold qualification affinity score;
determining a representative discounting affinity score based on a plurality of item discounting affinity scores each greater than or equal to a threshold discounting affinity score; and
calculating the offer score based on a linear combination of the representative qualification affinity score, the representative discounting affinity score, and the plurality of initial weights; and
generate the given offer based on a candidate offer having the highest offer score of the plurality of offer scores of the plurality of candidate offers.

15. The system of claim 11, wherein the offer selector is configured to generate the plurality of exploration offers by:
determining a rank of candidate offers associated with the given persona segment;
modifying the rank of the candidate offers associated with the given persona segment; and
selecting the plurality of exploration offers from a subset of the candidate offers above a predetermined ranking in the modified rank.

16. A non-transitory computer readable storage medium storing executable instructions that, when executed by one or more processors, cause the one or more processors to perform operations, the instructions comprising instructions to:
identify a pool of targeted users for a given offer characterized by a plurality of offer parameters;
segment the pool of targeted users into a plurality of persona segments, each persona segment characterized by a plurality of activity parameters;
determine a plurality of initial weights to apply to the respective plurality of offer parameters based on a given persona segment of the plurality of persona segments;
generate a plurality of exploration weights based on the plurality of initial weights;
generate a plurality of exploration offers based on the plurality of exploration weights;
transmit the plurality of exploration offers to a first subset of the given persona segment;
transmit the given offer to a second subset of the given persona segment;
track a first plurality of activities of the first subset associated with the plurality of exploration offers;
track a second plurality of activities of the second subset associated with the given offer;
generate a plurality of updated weights by updating the plurality of initial weights based on the first plurality of activities and the second plurality of activities; and
generate a subsequent offer for the given persona segment based on the plurality of updated weights.

17. The non-transitory computer readable storage medium of claim 16, wherein the instructions further comprise instructions to:
identify a pool of content items, the given offer applicable for a subset of the pool of content items;
segment the pool of content items into a plurality of content item segments; and
segment, based on the plurality of content item segments, targeted users of the given persona segment into a plurality of sub-segments of targeted users, and
wherein the generated subsequent offer is for a sub-segment of the plurality of sub-segments of targeted users.

18. The non-transitory computer readable storage medium of claim 17, wherein the instructions further comprise instructions to generate the given offer by, for each targeted user of the first subset, and for each candidate offer of a plurality of candidate offers:
determining, based on a content item segment of the plurality of content item segments, a preferred content item of the candidate offer, the preferred content item associated with a qualification affinity score and a discounting affinity score; and
calculating an offer score for the candidate offer based on a linear combination of the qualification affinity score, the discounting affinity score, and the plurality of initial weights.

19. The non-transitory computer readable storage medium of 16, wherein the instructions further comprise instructions to:
access a plurality of candidate offers from a database of historical offers, wherein each candidate offer is applicable for a plurality of content items, each content item of the plurality of content items associated with an item qualification affinity score and an item discounting affinity score;
determine, for each candidate offer of the plurality of candidate offers, an offer score by:
determining a representative qualification affinity score based on a plurality of item qualification affinity scores each greater than or equal to a threshold qualification affinity score;
determining a representative discounting affinity score based on a plurality of item discounting affinity scores each greater than or equal to a threshold discounting affinity score; and
calculating the offer score based on a linear combination of the representative qualification affinity score, the representative discounting affinity score, and the plurality of initial weights; and
generate the given offer based on a candidate offer having the highest offer score of the plurality of offer scores of the plurality of candidate offers.

20. The non-transitory computer readable storage medium of claim 16, wherein the instructions to generate the plurality of exploration offers comprise instructions to:
determine a rank of candidate offers associated with the given persona segment;
modify the rank of the candidate offers associated with the given persona segment; and
select the plurality of exploration offers from a subset of the candidate offers above a predetermined ranking in the modified rank.
